(19) United States
(12) Patent Application Publication
(10) Pub. No.: US 2008/0118705 A1
(43) Pub. Date: May 22, 2008

(54) Process for cutting heat applied indicia and indicia material made by the process

(76) Inventor: Brett A. Stahl, Grosse Pointe Farms, MI (US)

Correspondence Address: Christopher J. Fildes;Fildes & Outland, P.C., Suite 2, 20916 Mack Avenue, Grosse Pointe Woods, MI, 48236, US

(21) Appl. No.: 11/602,049

(22) Filed: Nov. 20, 2006

(51) Int. Cl. B32B 3/24; B23K 26/00; B26D 3/08

(52) U.S. Cl. 428/137; 83/880; 219/121.72

(57) ABSTRACT

A process for cutting at least one indicia adapted to be applied to an object includes providing a cutting device capable of cutting multiple depths; providing a material having an applicable layer and a supporting carrier layer; positioning the material relative to the cutting device; employing the cutting device to make at least one indicia cut through only the applicable layer of an outline of at least one indicia and at least one cavity cut through both the applicable layer and the carrier layer within the outline of the indicia to form a cavity surrounded by the indicia; and subsequent to the indicia cut, employing the cutting device to make a border cut through both the applicable layer and the carrier layer beyond the indicia to form an outline of a polygonal shape around the indicia. An indicia material made by the process is also disclosed.

### TECHNICAL FIELD

This invention relates to heat applied indicia, and more particularly to a process for cutting heat applied indicia to form a material having at least one heat applicable indicia thereon.

### BACKGROUND OF THE INVENTION

It is known in the art relating to heat applied indicia to provide a single indicia disposed on a carrier layer for transfer by tacking (i.e., heat application) to an article of clothing such as a sports team jersey, t-shirt, sweatshirt, jacket, apron, cap, etc., or to another suitable item capable of receiving the indicia. The indicia may be, for example, a letter, a number, or a graphic such as a baseball, football, or similar, and may be made of a thin layer of polymer material. The applicable indicia layer is supported by the carrier layer prior to transfer onto an object. To apply the indicia to an object such as an article of clothing, the indicia layer is placed face down on the object such that the indicia is disposed between the object and the carrier layer. The indicia may then be positioned by moving the indicia and corresponding carrier layer to a desired location on the object. Heat is then applied through the carrier layer, resulting in the indicia becoming fixed on the object. The carrier layer may then be freely removed and discarded, leaving a finished product.

Positioning of the indicia on the object, however, becomes difficult when more than one indicia must be applied to an object such as, for example, a sports jersey. Each indicia must be adjusted separately and must be aligned either by visual adjustment (“eye-balling”) or with the aide of a ruler and/or straight edge. It can be especially difficult to align numbers such as 4's and 7's that lack long peripheral edges that are parallel to the left-right and up-down axes of the number. It is similarly difficult to align certain letters. Further, it is also difficult to align numbering and/or lettering with indicia that are graphics such as baseballs, footballs, etc.

It is also known that when the applicable layer disposed on the carrier layer is cut to form indicia in the applicable layer, excess portions of the applicable layer around and within the indicia have to be manually weeded away (i.e., removed) prior to application of the indicia on an object. For example, if the indicia is a letter “A,” the portion of the applicable layer around the letter “A” must be removed as well as the portion of material within the upper portion of the “A.” Similarly, if the indicia is a letter “O,” the portion of applicable layer outside of the letter “O” must be removed as well as the portion of material enclosed by the “O.” Otherwise, these excess portions would also become adhered to the object during application of the indicia. The weeding away of excess material in the applicable layer is also tedious and time consuming, and further complicates the process of applying the indicia.

### SUMMARY OF THE INVENTION

The present invention provides a process for cutting indicia that results in less weeding away of material prior to application of the indicia on an object. The process also results in the pre-spacing and pre-positioning of letters, numbers, and/or graphics relative to each other. The indicia are cut such that they pre-spaced and pre-positioned on a single sheet of carrier material. This process thereby allows a user to avoid having to tediously adjust and position individual letters, numbers, and graphics relative to each other prior to application. Instead, the user simply adjusts the positioning of the entire letter/number/graphic combination relative to the transfer material by adjusting and aligning the edges of the carrier layer. The corners of the carrier layer may be used as reference points for accurate positioning. In addition, locating means such as notches or the like may be disposed around the carrier layer for positioning the indicia on an object.

More particularly, a process in accordance with the invention for cutting at least one indicia adapted to be applied to an object includes providing a cutting device capable of cutting multiple depths. Further, the process includes providing a material having an applicable layer and a supporting carrier layer. The material is positioned relative to the cutting device such that the material may be cut by the cutting device. The cutting device is employed to make at least one indicia cut through only the applicable layer of an outline of at least one indicia. The cutting device is also employed to make at least one cavity cut through both the applicable layer and the carrier layer within the outline of the indicia to form a cavity surrounded by the indicia. Subsequent to the indicia cut, the cutting device is employed to make a border cut through both the applicable layer and the carrier layer beyond the indicia to form an outline of a polygonal shape around the indicia, thereby pre-spacing and pre-positioning the indicia relative to the border cut.

Optionally, the cutting device may be a laser cutter, a flat bed cutter, or similar. The cutting device, however, may be any cutting device capable of cutting multiple depths. A supporting surface, such as a vacuum table or similar, may be provided, and the material may be positioned on the supporting surface prior to cutting. Alternatively, the cutting device may be a reel-to-reel cutting device that feeds the material from a first roll to a second roll, and the material may be held taught between the rolls.

The process may include making the border cut such that the indicia is centered relative to the outline formed by the border cut. The cutting device may also be employed to make more than one indicia cut through the applicable layer of an outline of at least two indicia to be applied side-by-side on an object. If more than one indicia is formed in the applicable layer, the indicia cuts are made such that the at least two indicia are pre-spaced and pre-positioned relative to each other and relative to the border cut. The polygonal shape formed by the border cut may be a rectangle or a square, although any polygonal shape is within the scope of the invention.

In one embodiment of the process, the applicable layer may include a thermoplastic. More specifically, the applicable layer may be a composite film including a thermoplastic polyurethane or PVC and a thermoplastic adhesive. Alternatively, the applicable layer may be a heat transferable fabric. Further, the carrier layer may be a paper release sheet or alternatively a polyester film. The invention, however, is not limited to these specific materials.

A material for applying at least one indicia onto an object includes a supporting carrier layer and an applicable layer disposed on the carrier layer. The applicable layer includes an indicia outlined by an indicia cut through the applicable layer. The carrier layer has an outer boundary beyond the indicia. The outer boundary defines an outline of a polygonal shape around the indicia. At least one cavity is surrounded by the indicia within the outline of the indicia. Each cavity is defined by a cavity cut through both the applicable layer and the carrier layer. Each cavity reduces the weeding away of excess portions of the applicable layer prior to application of the indicia to an object.

Optionally, the indicia may be centered relative to the outer boundary of the carrier layer. The indicia may also be one of a letter, a number, or a graphic. Further, the applicable layer may include more than one indicia positioned on the carrier layer in a spatial relationship relative to each other that corresponds to the spatial relationship the indicia are to have relative to each other when applied to an object.

The polygonal shape outlined by the outer boundary of the carrier layer may be a rectangle or a square, although the invention includes any polygonal shape. Further, the material may have a margin adjacent each side of the polygonal shape. Each of the margins is defined between the outer boundary and the indicia, and opposite margins of the material are equivalent in size.

In one embodiment, the applicable layer may be a heat transferable fabric or alternatively a thermoplastic. The carrier layer may be a paper release sheet or alternatively a polyester film. The invention, however, is not limited to these specific materials.

These and other features and advantages of the invention will be more fully understood from the following detailed description of the invention taken together with the accompanying drawings.

### BRIEF DESCRIPTION OF THE DRAWINGS

In the drawings:

FIG. 1 is an environmental view of a cutting device cutting a material in accordance with the invention;

FIG. 2 is a plan view the material of FIG. 1 illustrating indicia cuts, border cuts, and cavity cuts made by the cutting device;

FIG. 3 is a side cross-sectional view of the material taken along the line 3-3 in FIG. 2;

FIG. 4 is a plan view of a material according to the invention for applying at least one indicia onto an object; and

FIG. 5 is a side view of the material of FIG. 4.

### DETAILED DESCRIPTION OF THE INVENTION

Referring now to the drawings in detail, numeral 10 generally indicates a cutting device such as a laser cutter, a flat bed cutter, or similar for use in a process for cutting indicia adapted to be applied to an object. The cutting device 10 is not limited to any specific type of cutting device. The cutting device 10 merely needs to be capable of cutting multiple depths. The cutting process results in a reduction in the amount of material that must be weeded away prior to application of the indicia, thereby simplifying and speeding up the application process. The cutting process may also result in the pre-spacing and pre-positioning of letters, numbers, and/or graphics relative to each other on a single sheet of carrier material. This allows a user to easily adjust the positioning of the indicia on the object to which the indicia are to be applied prior to application, thereby eliminating the tedious adjustment of individual letters, numbers, and graphics relative to each other.

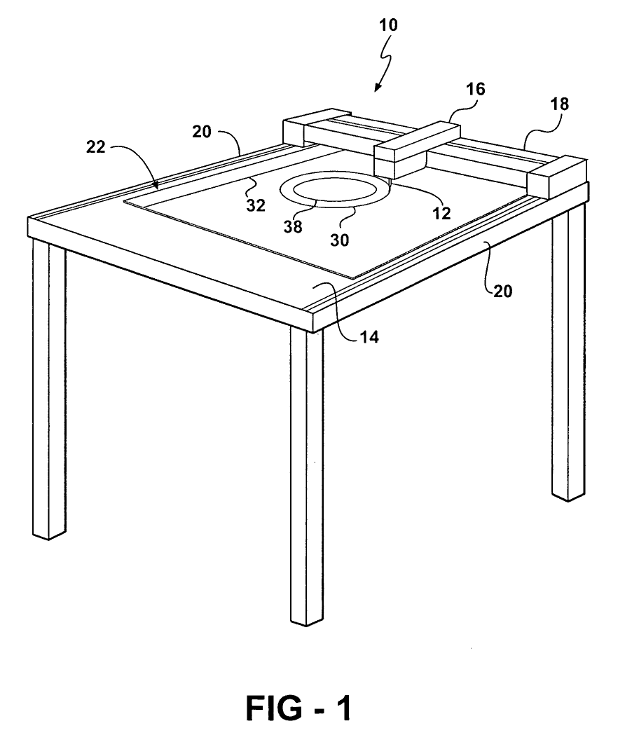

With reference to FIG. 1, the cutting device 10 includes a cutting head 12. The cutting head 12 may include a blade, knife, or laser cutter capable of cutting multiple depths. A supporting surface 14 may be provided, and the cutting head 12 may be capable of cutting multiple depths relative to the supporting surface 14. The cutting head 12 may be supported by a carriage 16 that is movable along a guide 18. The guide 18 itself may be movable along opposite edges 20 of the supporting surface 14 via guides (not shown). This allows the cutting head 12 to be oriented and moved in any direction relative to the supporting surface 14. The supporting surface 14 may be a vacuum table or similar, wherein during use the vacuum draws air from above the supporting surface 14 to an underside of the supporting surface, thereby immobilizing an item placed on top of the supporting surface.

Alternatively, a reel-to-reel cutting device may be provided that feeds material from a first roll to a second roll. The material may be held taught between the rolls, and the material may or may not contact a supporting surface between the rolls. The tension exerted on the material between the rolls may be sufficient to hold the material in place, and in this case no supporting surface is necessary. Although the invention is described below by example of a flat bed cutter having a vacuum table supporting surface, it should be understood that the invention is not limited to this embodiment, and a reel-to-reel cutting device may be substituted for the vacuum table.

Turning now to FIGS. 1 through 3, in the process according to the invention, a material 22 having an applicable layer 24 and a supporting carrier layer 26 is used. The applicable layer 24 may include a thermoplastic or heat transferable fabric and may be a composite film including a thermoplastic polyurethane or a composite film including PVC and a thermoplastic adhesive such as a polyester, polyurethane, PVC adhesive or similar. The applicable layer 24 also typically includes a pigment to give color to the applicable layer. As an example, the applicable layer 24 may be Thermo-FILM®-brand material available from Stahls' Inc., or Web Flex®-brand material from R.J. Liebe Co., but other similar materials are acceptable. Suitable heat transferable fabric materials include Poly-TWILL™-brand material available from Stahls' Inc. The specific type of film/material chosen for the applicable layer 24 depends in part on the material of the object that the applicable layer is to be adhered to. The carrier layer 26 may be a polyester film, such as Mylar®-brand polyester film available from DuPont or Magic Mask® available from Stahls', or the carrier layer 26 may be a paper release sheet such as Transel™-brand paper release sheets available from One Step Papers. The carrier layer 26 supports the applicable layer 24 until the applicable layer 24 is applied to an object through the use of heat, as described in more detail below. The material 22 is relatively thin and sheet-like, and may be rolled into a roll for easy transportation, storage, and dispensing during use.

The material 22 is positioned relative to the flat bed cutter 10 (see FIG. 1). More specifically, the material 22 is positioned on the supporting surface 14 such that the material lies flat on the supporting surface and within the edges 20 of the supporting surface. If the supporting surface 14 is a vacuum table, the vacuum (not shown) may be activated to suck the material 22 to the surface so that the material is immobilized.

After the material 22 is positioned on the supporting surface 14, the cutting head 12 may be used to make cuts in the material. In the process according to the invention, an outline of at least one indicia 28 to be applied to an object is formed by at least one indicia cut 30 through the applicable layer 24. An indicia 28 is herein defined as a single character such as a letter, number, or symbol, or a single graphic such as a baseball, football, or similar. The indicia cut(s) 30 are only in the applicable layer 24 and do not penetrate the carrier layer 26, thereby leaving the carrier layer intact adjacent the indicia 28. Based upon the location of the indicia cuts 30, if at least two indicia are formed side-by-side in the applicable layer, the indicia cuts are made such that the indicia 28 are pre-positioned and pre-aligned relative to each other. In this case, the at least two indicia are also positioned on the carrier layer 26 in a spatial relationship relative to each other corresponding to the spatial relationship the indicia are to have relative to each other when applied to an object.

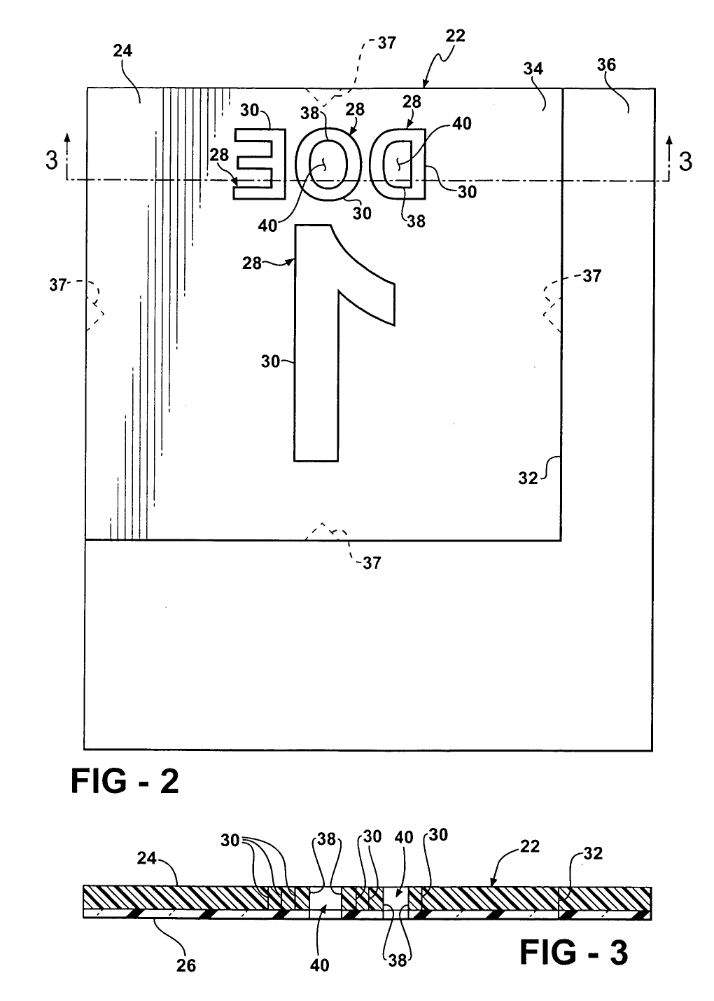

Further, a border cut 32 is made through both the applicable layer 24 and the supporting carrier layer 26 beyond the indicia cut(s) 30 to define an outer boundary of the material 22. The outer boundary forms a polygonal shape defined by the border cut 32 and also optionally by any pre-cut and/or pre-existing edges of the material 22. The border cut 32 separates the material 22 into pieces 34, 36. One of the pieces, namely piece 36, is a scrap portion of material that may be discarded. The other piece 34 includes the indicia 28 for later application to an object. In the example shown in FIG. 2, the border cut 32 defines two sides of a polygonal shape while the other two sides of the polygonal shape are defined by pre-existing edges of the material 22. The polygonal shape is preferably a parallelogram such as a rectangle or a square, as these shapes are the easiest to align on an object for application of the indicia (see below). The polygonal shape, however, may be any other polygon such as a triangle, pentagon, hexagon, etc.

The border cut 32 may be made such that the indicia 28 is centered relative to the outer boundary formed by the border cut. This allows for easier application of the indicia 28 to an object as centering the carrier layer 26 would then also result in the centering of the indicia 28 supported by the carrier.

A cavity cut 38 is also made through both the applicable layer 24 and the carrier layer 26 within the outline of the indicia 28 to form a cavity 40 surrounded by the indicia 28. In essence, when the cavity cut 38 is made, the portion of material surrounded by the cavity cut 38 becomes detached from the material 22 and may be discarded, thereby leaving a cavity 40 in its place. One or more cavity cuts 38 may be made for each indicia 28, depending upon the indicia. For example, if the indicia 28 is a “D” or an “O,” one cavity cut 38 would be made for each indicia. The cavity cut 38 within the “D” creates a cavity 40 within the “D,” and the cavity cut 38 within the “O” creates a cavity 40 within the “O.” Further, a number “8” is an example of an indicia in which two cavity cuts would be made, forming two cavities in the “8,” one in the upper portion of the “8” and one in the lower portion. From these examples, it can be seen that a cavity 40 is an empty space within an indicia. Forming a cavity 40 by a cavity cut 38 reduces the weeding away (i.e., removal and discarding) of excess portions of the applicable layer 24 prior to application of the indicia 28 to an object by eliminating the presence of the applicable layer 24 and carrier layer 26 in the space defined by the cavity 40. Hence, the cavity 40 eliminates the need for a person to manually weed away the portion of applicable layer 24 that would have occupied the space in the cavity 40.

After the indicia cut(s) 30, cavity cut(s) 38, and border cut(s) 32 are made, the resulting piece of material 34 may then be used to easily align the indicia 28 on an object for application. The object may be an article of clothing such as a sports team jersey, t-shirt, sweatshirt, jacket, apron, cap, etc. (i.e., objects made of fabric materials), or an article such as a water bottle, hockey puck, lawn sign, or even a window pane. For purposes of example, the object will be hereinafter referred to as a jersey. The area on the jersey where the indicia 28 are to be located is laid flat on a smooth surface. All of the excess applicable layer 24 outside of the outline(s) of the indicia 28, in other words, the pieces/portions of applicable layer that do not form the indicia 28, are weeded away. Due to the presence of the cavity 40, no portions of applicable layer exist within the indicia 28 that would otherwise have to be removed and discarded prior to application of the indicia 28. Next, the piece of material 34 is placed on the jersey with the applicable layer 24 disposed between the jersey and the carrier layer 26. The indicia 28 are then positioned relative to the jersey simply by adjusting the piece of material 34 and by aligning the edges of the polygonal shape of the carrier layer 26 of the material 34 with seams or other distinguishing features of the jersey such as the collar. Alternatively, the outer boundary line may have a notch 37 on sides thereof to indicate, for example, the center line or other reference of the indicia 28 for positioning purposes. Then, heat is generally applied to the positioned indicia 28 through the carrier layer 26, causing the indicia 28 to adhere to the jersey. The carrier layer 26 is then removed, leaving a jersey with accurately aligned indicia 28.

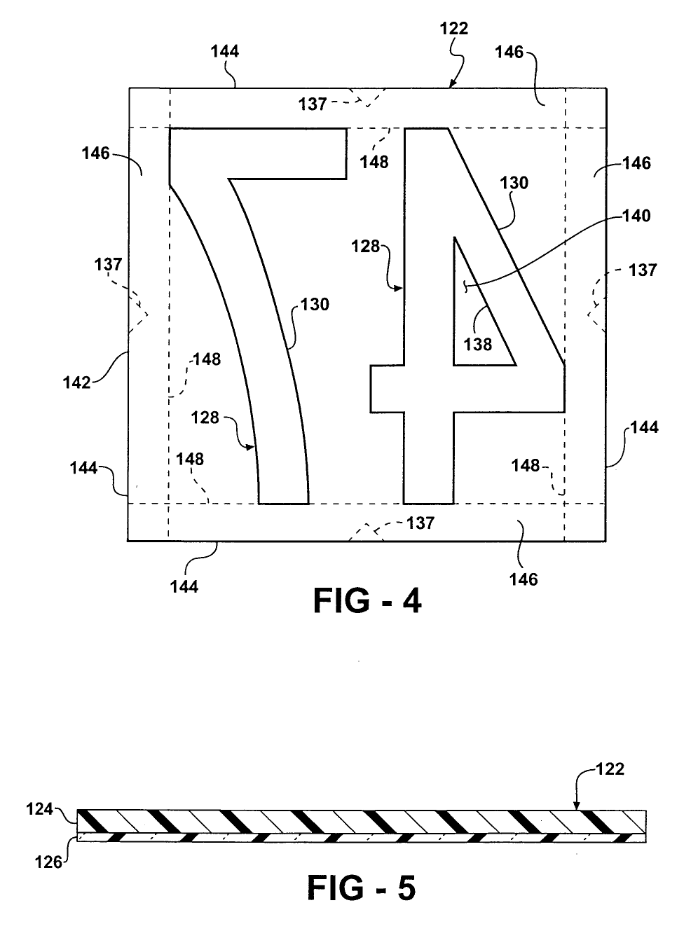

With reference to FIGS. 4 and 5, in an alternative embodiment, a material 122 according to the invention for applying indicia 128 onto an object includes an applicable layer 124 and a supporting carrier layer 126. The applicable layer 124 is disposed on the carrier layer 126. The applicable layer 124 and the carrier layer 126 may have similar properties to the applicable layer 24 and carrier layer 26 above.

The material 122 further includes at least one indicia 128 in the applicable layer 124 defined by one or more indicia cut lines 130 through the applicable layer 124. The indicia cut lines 130 do not extend into the carrier layer 126. For purpose of example, in FIG. 4 two indicia 128 are shown as the numbers “4” and “7.” It should be understood, however, that the indicia 128 may also be letters, graphics, symbols, etc. It should also be understood that only a single indicia 128 is required by the invention. The indicia 128 are positioned on the carrier layer 126 in a spatial relationship relative to each other corresponding to the spatial relationship the indicia are to have relative to each other when applied to an object (as described above).

The material 122 also includes at least one cavity 140 surrounded by the indicia 128 within the outline of the indicia 128. The cavity 140 is defined by a cavity cut 138 through both the applicable layer 124 and the carrier layer 126. In the example shown in FIG. 4, the cavity 140 is in the upper portion of the number “4.”

In a specific embodiment, the material 122 may have an outer boundary 142 defining a polygonal shape having sides 144. The sides 144 themselves define the outer boundary 142. The indicia 128 are disposed within the outer boundary 142. As described above, the polygonal shape is preferably a parallelogram such as a rectangle or square, but may also be any other polygon such as a triangle, pentagon, hexagon, etc.

The material 122 may further have a margin 146 adjacent each side 144 of the polygonal shape. Each of the margins 146 is defined as the space between the outer boundary 142 and an indicia cut line 130 of the indicia 128. The edge of the indicia cut line 130 closest to each side 144 of the polygon defines the inner boundary 148 of each margin 146. More simply, the margins 146 of the material 122 are similar to margins on a document; the margins 146 are the outer portion of the “sheet” of material in which there are no indicia 128 present. In this embodiment, opposite margins 146 of the material 122 may be equivalent in size. This aides in the left-right and up-down alignment of the material 122 on an object to which the indicia 128 are to be adhered because the indicia 128 are then an equal distance from opposing sides 144 of the material 122. Optionally, the sides 144 of the material 122 may also include a notch 137 to indicate, for example, the center line or other reference of the indicia 128 for positioning purposes.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A process for cutting at least one indicia adapted to be applied to an object, the process comprising the steps of:
providing a cutting device capable of cutting multiple depths;
providing a material having an applicable layer and a supporting carrier layer;
positioning said material relative to said cutting device;
employing said cutting device to make at least one indicia cut through only said applicable layer of an outline of at least one indicia;
employing said cutting device to make at least one cavity cut through both said applicable layer and said carrier layer within said outline of said indicia to form a cavity surrounded by said indicia;
subsequent to said indicia cut, employing said cutting device to make a border cut through both said applicable layer and said carrier layer beyond said indicia to form an outline of a polygonal shape around said indicia, whereby said indicia is pre-spaced and pre-positioned relative to said border cut.

2. The process of claim 1, including the step of making said border cut such that said indicia is centered relative to the outline formed by said border cut.

3. The process of claim 1, wherein said cutting device is employed to make more than one indicia cut through said applicable layer of an outline of at least two indicia to be applied side-by-side on an object; and
said at least two indicia are pre-spaced and pre-positioned relative to each other and to said border cut.

4. The process of claim 1, wherein said polygonal shape is one of a rectangle and a square.

5. The process of claim 1, wherein said cutting device is one of a laser cutter and a flat bed cutter.

6. The process of claim 1, including the steps of:
providing a supporting surface cooperable with said cutting device; and
positioning said material on said supporting surface.

7. The process of claim 1, wherein:
said cutting device is a reel-to-reel cutting device that feeds said material from a first roll to a second roll, and said material is held taught between said first and second rolls.

8. The process of claim 1, wherein said applicable layer includes a thermoplastic.

9. The process of claim 1, wherein said applicable layer is one of a heat transferable fabric and a composite film including a thermoplastic polyurethane or PVC and a thermoplastic adhesive.

10. The process of claim 1, wherein said carrier layer is one of a paper release sheet and a polyester film.

11. A material for applying at least one indicia onto an object, the material comprising:
a supporting carrier layer;
an applicable layer disposed on said carrier layer;
said applicable layer including an indicia outlined by an indicia cut through said applicable layer;
said carrier layer having an outer boundary beyond said indicia, said outer boundary defining an outline of a polygonal shape around said indicia; and
at least one cavity surrounded by said indicia within said outline of said indicia, each cavity being defined by a cavity cut through both said applicable layer and said carrier layer;
wherein said at least one cavity reduces the weeding away of excess portions of said applicable layer prior to application of said indicia to an object.

12. The material of claim 11, wherein said indicia is centered relative to said outer boundary of said carrier layer.

13. The material of claim 11, wherein said applicable layer includes more than one indicia positioned on said carrier layer in a spatial relationship relative to each other corresponding to the spatial relationship the indicia are to have relative to each other when applied to an object.

14. The material of claim 11, wherein said indicia is one chosen from a group of a letter, number, and graphic.

15. The material of claim 11, wherein polygonal shape outlined by said outer boundary of said carrier layer is one of a rectangle and square.

16. The material of claim 11, wherein said material has a margin adjacent each side of said polygonal shape, each of said margins being defined between said outer boundary and said indicia; and
opposite margins of said material are equivalent.

17. The material of claim 11, wherein said carrier layer is one of a paper release sheet and a polyester film.

18. The material of claim 11, wherein said applicable layer includes one of a heat transferable fabric and a thermoplastic.
